(19) United States
(12) Patent Application Publication
(10) Pub. No.: US 2002/0178181 A1
(43) Pub. Date: Nov. 28, 2002

(54) Method and system for creation and development of content for e-learning

(76) Inventors: Shyam K Subramanyan, Union City, CA (US); Abhijeet Prakash Vaidya, Cupertino, CA (US); Alan C. Brown, Sunnyvale, CA (US); David W. Noland, Campbell, CA (US); Ravikumar N. Mysore, Bridgewater, NJ (US)

Correspondence Address: WHITE & CASE LLP, PATENT DEPARTMENT, 1155 AVENUE OF THE AMERICAS, NEW YORK, NY, 10036, US

(21) Appl. No.: 09/863,707

(22) Filed: May 23, 2001

(51) Int. Cl. G06F 17/24; G09G 5/00

(52) U.S. Cl. 707/501.1; 345/731; 345/751

(57) ABSTRACT

The present invention relates to a network or internet-based system and method for collaboratively creating, developing, and integrating content and information for eLearning and knowledge management.

### FIELD OF THE INVENTION

The present invention relates to the fields of eLearning and knowledge management. In particular, the present invention relates to a network or internet-based system for integrating and using various media, files, and information which enables clients and other users to create, maintain, update, manage, and use knowledge and content collaboratively.

### BACKGROUND OF THE INVENTION

In today's economy, knowledge counts more than anything. Knowledge has value, and so does one's ability to create, manage, and convey knowledge. For example, in a world where the internet spreads knowledge instantaneously around the world through various networks reaching billions of people, those who best create, manage, and control the dissemination, content, and integration of knowledge and information will realize the greatest benefits from their efforts.

Knowledge is acquired through study, investigation, observation, and experience. It is conveyed through teaching, mentoring, and acting. The field of knowledge management deals with the collection, categorization, and storage of knowledge and information—the focus is on archiving and managing vast amounts of information, usually without any structured means for conveying the information to others. For example, the archiving of thousands of documents or recordation of certain experiences. Others may study, investigate, search, or retrieve the collected material, but this is in isolation and is not a part of a structured training program where it is used as a relevant case study.

The field of eLearning deals with the process of disseminating information in a very structured manner. It normally includes an objective, a definite mechanism or a set of instructions by which the objective can be achieved, and most often some assessment to confirm that the objective has been met. By its very definition it is delivered using some electronic medium. The eLearning medium can be compared to the old medium or conventional training medium where training happened in classrooms with instructors and tests, scores, and homework—the only difference being that all of this is now virtual and it happens online. Accordingly, the keys to eLearning are the collection and creation of information developed into a structured training mechanism.

The collection process, or knowledge creation aspect, is difficult. In the main, information in multiple media (including documents, video, audio, and animation files, among others) available on-line pertaining to a specific topic is scattered among many individuals, and assembling all the relevant content required to make a meaningful eLearning program in one place is time-consuming and oftentimes expensive. Even for professional content developers it takes a great deal of time and effort to assemble multiple media information from a variety of sources, including the internet, individuals, corporate entities, etc., in a attempt to bring it all together to achieve an objective.

Integrating the collected material into an eLearning context comprising structuring and developing of the information to achieve an objective (loosely called storyboarding) is even more time intensive and expensive. For example, the collection, creation, and development processes are extensive and complex, with development team members exchanging a myriad of files in different formats via e-mail, FTP, or even postal mail. These types of communications did not always work well, so team members would often have to make a second, third, or fourth communication, or in some cases, make several trips for meetings and pay great sums of money on long distance telephone bills.

What is desired, therefore, is a method and system collecting, creating, and developing content for eLearning, which will simplify and improve the process of storyboarding by enabling team members to communicate and develop storyboards more efficiently and definitively. Preferably, this system and method would exist in a network or world wide web setting, more preferably in a setting which allows team members to collaborate, communicate, and interact with a multitude of media files, information, and presentations online simultaneously. A method and system for integrating knowledge management and content development, including collecting and assembling various types of information, knowledge, or both, developing a storyboard based upon such knowledge and information, and managing the user and workflow through and within the storyboard via a storyboard server is also desired. A method and system which is relatively inexpensive, cost-effective, and user-friendly is also desired.

### SUMMARY OF THE INVENTION

Accordingly, it is an object of the present invention to provide a method and system for creating content for eLearning which simplifies and improves the storyboarding process.

Another object of the present invention is to provide a method and system for creating content for eLearning wherein the storyboarding process comprises collaboratively deciding the objectives of the eLearning program, defining the audience for the same and, based on the objectives and audience, to collect information that goes into making the program, structuring it, breaking it in modules of the appropriate sizes, and defining the look and feel of the program.

Another object of the present invention is to provide a method and system of the above character that is network-based and thereby accessible to multiple users or team members generally and simultaneously. Such a method and system obviates many of the typical communication and developmental delay problems involved in the current method of storyboarding, which is a very manual process.

Another object of the present invention is to provide a method and system of the above character that is internet-based and thus accessible to multiple users generally and simultaneously. Such a system further obviates many of the typical communication and developmental delay problems involved in the current, very manual method of storyboarding.

Another object of the present invention is to provide a method and system for creating and developing content for eLearning that allows team members to collaborate via some network, including the internet, during the storyboarding processes, i.e., collecting, creating, and developing, particularly to enable team members to interact, collaborate, and communicate instantaneously, as well as download, upload, use, or otherwise share and manipulate multiple media files during the development of a storyboard, preferably through a storyboard server.

It is further an object of the present invention to provide a method and system of the above character including collecting, assembling, and structuring various types of information or knowledge, creating and developing a storyboard based upon such knowledge, and managing the workflow through and within the storyboard via a storyboard server.

It is also an object of the present invention to provide a method and system of the above character including developing a storyboard based in part on background information relating to target audience information, including demographics, or user compatibility information.

It is also an object of the present invention to provide a method and system of the above character including developing a storyboard server which collects multiple media files, delegates tasks, and provides feedback to team members and users.

It is also an object of the present invention to provide a method and system of the above character including developing a storyboard server which has a built-in version control that enables team members and users to view changes in their work and revert back to older versions.

It is also an object of the present invention to provide a method and system of the above character including developing a storyboard server with the capability of allowing team members and users to chat on-line and share a virtual whiteboard or other type of e-transferable drawing or communicative template or device.

It is also an object of the present invention to provide a method and system of the above character useful for e-teaching and developing e-courses or classes on-line.

It is also an object of the present invention to provide a network or internet-based method and system for the creation and development of content for eLearning access to which may be unlimited (available publicly to the entire network or available over the internet), limited (to specific people using user names and passwords or the like), or highly secure (using secure and encrypted technology or connections), depending on the nature and sensitivity of the content.

Another object of the present invention is to provide a method and system for integrating knowledge management and eLearning employing the storyboarding process to collect information in a structured manner and use it as just in time unstructured knowledge as well as use it in structured eLearning programs.

These and other objects of the invention are achieved by provision of network or internet-based methods and systems for creating and developing content for eLearning and for integrating knowledge management and eLearning. Each system includes a storyboard server networked with a network, including, for example, the internet, and means for users to access the network and server and to receive services from the server. The preferred system includes a storyboard server networked with a user through to the internet enabling user access to the storyboard server. The storyboard server comprises a software system which enables the users to avail itself of or use all the functionality mentioned above.

The invention and its particular features and advantages will become more apparent from the following detailed description considered with reference to the accompanying drawings.

### BRIEF DESCRIPTION OF THE DRAWINGS

FIG. 1 is a diagram of a system in accordance with the invention.

FIG. 2 shows the functionality of the storyboard server as a flow diagram in accordance with the present invention.

FIG. 3 shows the evolution of content being developed through and with the storyboard server in accordance with the present invention.

### DETAILED DESCRIPTION OF A PREFERRED EMBODIMENT

1. SYSTEM SET-UP

a. Server Connectivity

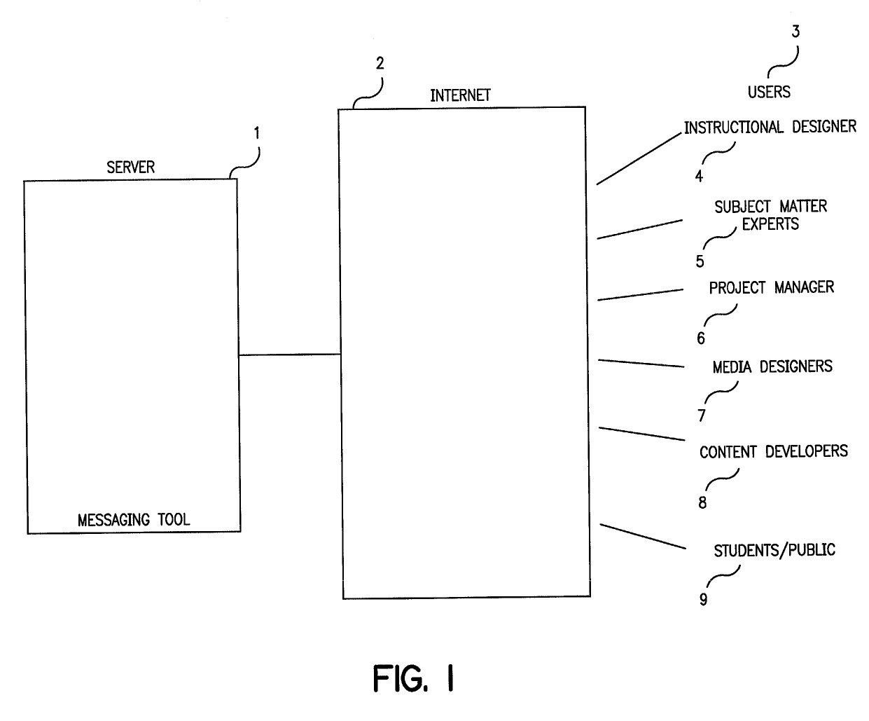

FIG. 1 depicts an internet-based method and system for creating and developing content for eLearning in accordance with the present invention. A storyboard server 1 is networked with the internet 2 using methods known in the art of internet networking and service providing. The storyboard server 1 is, generally, a computer program that provides services to users 3 accessing it via the internet 2 with other computers and programs for receiving services from the storyboard server. Specific to the internet or World Wide Web (Web), a Web-based storyboard server 1 is the computer program that serves requested HTML pages or files to clients or users 3. The client is the requesting program associated with the user 3.

The storyboard server 1 is also a module which reduces the cost of content development by reducing the project management overhead out of the cost of content development. The storyboard server 1 allows users, such as, for example, Instructional Designers (IDs) 4, Subject Matter Experts (SMEs) 5, Project Managers (PMs) 6, Media Designers (MDs) 7, HTML and DHTML Content Developers (CDs) 8, and others 9 to collaboratively develop content by scripting and reviewing the storyboard with its corresponding implementation online via the internet 2. This storyboard server allows media designers 7 to provide media files, including, for example, text, graphics, animation, video, or audio files, instructional designers 4 to design and script the storyboard, HTML developers to develop the content of the pages, and all members of the project to provide feedback and sign off on the content.

b. Server Configuration

The storyboard server comprises a number of enabling software tools and databases, including a storage database and file system, a templating tool, an authoring tool, a page level storyboarding tool, a messaging tool, a version control tool, and a synchronous communication tool. The storage database and file system allows users to upload, download, copy, etc., multiple media files to and from the storyboard server. The files may be saved in the database, organized in the file system, and accessed by users when necessary.

The templating tool of the storyboard server enables users, for example, an instructional designer, to design templates, or e-document macros or questionnaires, including questions and ideas to be answered and explained by other users, for example, a subject matter expert. The templates are designed and routed through the storyboard server, and the accessed and completed by subject matter experts via the network or internet. Once completed, the templating tool or engine may automatically create learning objects in the next storyboarding step.

The authoring tool of the storyboard server enables users, such as instructional designers and project managers, to create learning objects from a collection of subject matter and further develop learning paths based upon the learning objects. A learning object is a specific idea or topic to be incorporated into the story of a storyboard. A learning path is the path or flow of frames of information based upon learning objects in which the instructional or informational data is communicated to users. The authoring tool enables instructional designers to create learning objects based upon subject matter entered into templates by subject matter experts. The instructional designer, also using the authoring tool, then uses his or her expertise to design learning paths to best communicate the subject matter in an instructional or other manner.

The page level storyboarding tool enables users, such as content developers and media designers, to create network or webpages based upon the design of the learning paths, as developed by the instructional designer, and incorporate or upload these pages to the storyboard server. The pages created using the page level storyboarding tool include media, for example, video, audio, text, graphics, and animation, designed and integrated according to the learning paths to communicate the objectives of the project.

Each of these tools comprising the storyboard server, the templating, authoring, and page level storyboarding tools, work in conjunction with other storyboard tools to facilitate and integrate the storyboarding process, including a messaging tool, a version control tool, and a synchronous communication tool. The messaging tool enables users to communicate with each other. For example, if a template is created by an instructional designer and ready for use or completion by a subject matter expert, the instructional designer need only create the template in the storyboard and indicate that it is ready. The storyboard messaging tool will then automatically send a message, such as by e-mail, to the subject matter expert indicating that the template is ready for his or her attention. The messaging tool may similarly send automatic e-mail or other messages to users at various points in the storyboarding process for any number of reasons.

The version control tool enables users to access, edit, copy, etc., previous versions of work contained in the storyboard server, including templates, empty learning objects and learning paths, frames, pages, and edited content or subject matter, as well as any textual information.

The synchronous communication tool enables users to collaborate in both developing and using the storyboard and storyboard server. This tool allows each participant in the development of the storyboard to access and use each component of the storyboard simultaneously from remote locations, if necessary.

c. Storyboard Design

A storyboard is a communication and communication management tool, which an Instructional Designer uses to convey the elements of the story to be developed and played out. A storyboard is also a network or e-document, which comprises information in an audio segment and a visual segment. The audio segment comprises narration or music. The visual segment comprises text, graphics, pictures, photos, video, or animation. The content developers or designers analyze and interpret the storyboard as designed by the Instructional Designer and create pages, including, for example, HTML and Dynamic HTML (DHTML) pages, that render the story of the storyboard on the screen of a network device or computer.

Each storyboard of this embodiment of the present invention comprises audio and visual segments or elements for one screen. There are means within the storyboard for expressing narrative text for the audio segment or elements and text for display of the visual segment or elements. The storyboard may also include multiple audio narratives or multiple visual elements on one screen. The storyboard additionally comprises means for specifying the sequences in time for the rendering or utilization of audio and visual elements. These timing means allow the audio and visual segments to be played out synchronously. The storyboard also comprises messaging and tracking or version control.

d. Storyboard Content Flow & Evolution

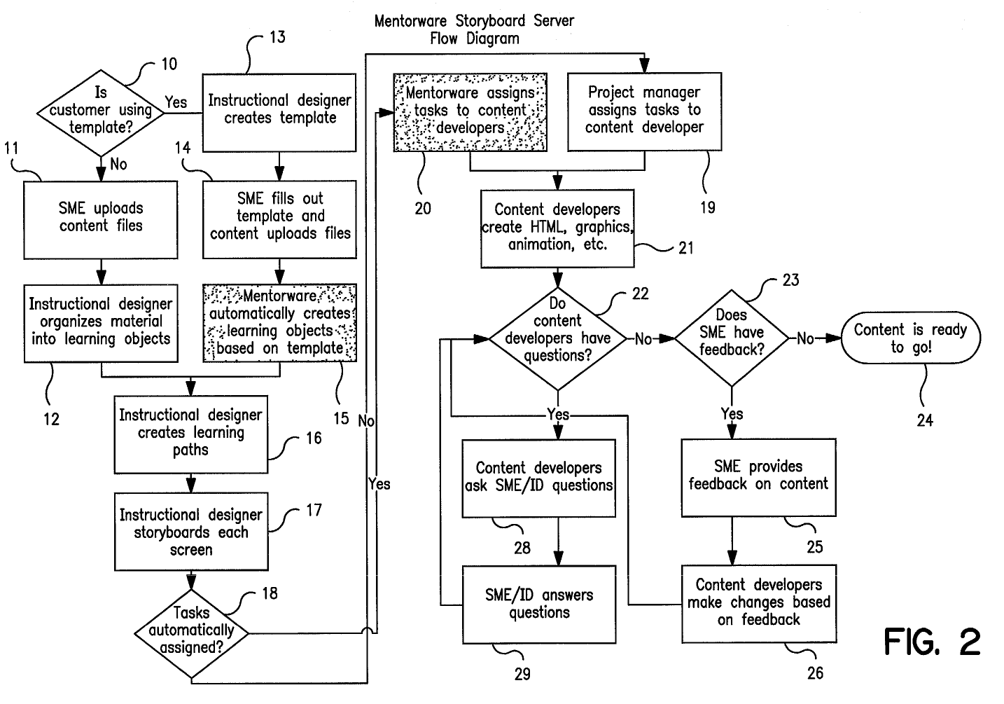

FIG. 2 is a flow diagram depicting the development of a storyboard in the storyboard server. The first consideration, whether a customer is using a template 10 involves determining whether the customer or client desires to use a template for organizing and integrating relevant subject matter received from subject matter experts. If a customer is using templates, the templates for that project may be developed by the instructional designer in collaboration with subject matter experts, the customer, the project manager, or others. The templates are developed and created based upon the objectives of the project, the client's needs and requirements, the content, the expertise of the instructional designer, and the intended audience. As for the intended audience of users, it may be determined by consultation with the customer or client, as well as by evaluating user demographics, psychographics, expertise levels, profiles, and network and system capabilities.

Once the templates are developed for the project, they are created in the storyboard server 13 using the storyboard server templating tool for access and completion by subject matter experts 14. The subject matter expert can provide content by using the template to collect content or specific information from him or her about a subject. The subject matter expert may categorize or characterize the raw content uploaded to the storyboard server by designating the material as, for example, write-ups, manuals, audio, video, or graphics. The subject matter expert may enter or characterize the main or terminal objective of the material and the more specific or enabling objectives, and information on the user environment and audience demographics.

Once the subject matter expert completes or fills in the template, the content is uploaded to the storyboard server. The storyboard server then may automatically create learning objects based on the templates 15. Learning objects derived from the template are based upon how the instructional designer configured the template for the subject matter expert. In addition, learning objects may be generated by the storyboard server by using keyed or coded templates designed by the instructional designer to recognize each subject matter file in the template as corresponding to a specific predetermined learning object. Depending on the content uploaded, the predetermined learning objects may, of course, be modified to more accurately reflect the intent or object of the instructional designer or customer.

If the customer is not using templates, the subject matter expert, or some other person with access to the relevant subject matter, will directly upload the subject matter content files 11 to the storyboard server, such as into the storyboard server database and file system. These uploaded files may not be organized in template form. The instructional designer will then organize the content files into learning objects 12.

Once learning objects are created in the storyboard server, the instructional designer may create learning paths 16 incorporating the learning objects. Using the storyboard server authoring tool, the instructional designer storyboards each screen or frame 17. The instructional designer may also build the logic for learning paths. In storyboarding each screen, the instructional designer determines how each learning path should flow, the media used to develop such flow, and designates for each screen in the learning path the timing, sequencing, and synchronization of the content and media to carry out, develop, or execute that learning path. The screen storyboard contains elements such as visual, audio, effects, transitions, navigation, text, and references. These elements can be time sequenced and synchronized. Each element may have additional classifications and characterizations, for example, an audio sample could be a male voice-over or a female voice-over. The storyboard for all screens in a learning object can be displayed and printed on the screen. The users, such as the project manager, can search learning objects' storyboards for a particular element or group of elements, for example, a list of all female voice-over audio or all graphics.

Once each screen is storyboarded or framed, the tasks of developing actual network or webpages based on the storyboarded learning paths and incorporating the instructional designers storyboard frames are determined and assigned. The storyboard server may include an automatic assigning component 20, which may utilize the storyboard server messaging tool, or the tasks may be assigned by the project manager 19. The tasks are assigned to content developers, which may include HTML developers, graphic designers, animation designers, video developers, or other media designers. The content developers, using, among other things, the storyboard server page level storyboarding tool, design and implement the storyboard pages based upon the learning paths framed by the instructional designer and incorporate the designated media.

Users, including content developers, may post questions 22 regarding, for example, learning objects or paths or frames, which other users will receive. Collaboration continues between and among the users and developers to provide and receive feedback on the project and any questions asked 28. The parties requested for assistance will then provide feedback to the content developers 29. The subject matter experts may have 23 and provide 25 feedback on the content as well. Project managers and other users can mark the subject matter experts' feedback as a defect, enhancement, or change, or other customized designation. This designation process may assist the project manager in costing changes that result from feedback. As templates, learning objects, and frames are modified, a history of these items is stored in the storyboard server. Users can revert back to previous versions. When the users and developers sign off on the content, the content is ready to go 24.

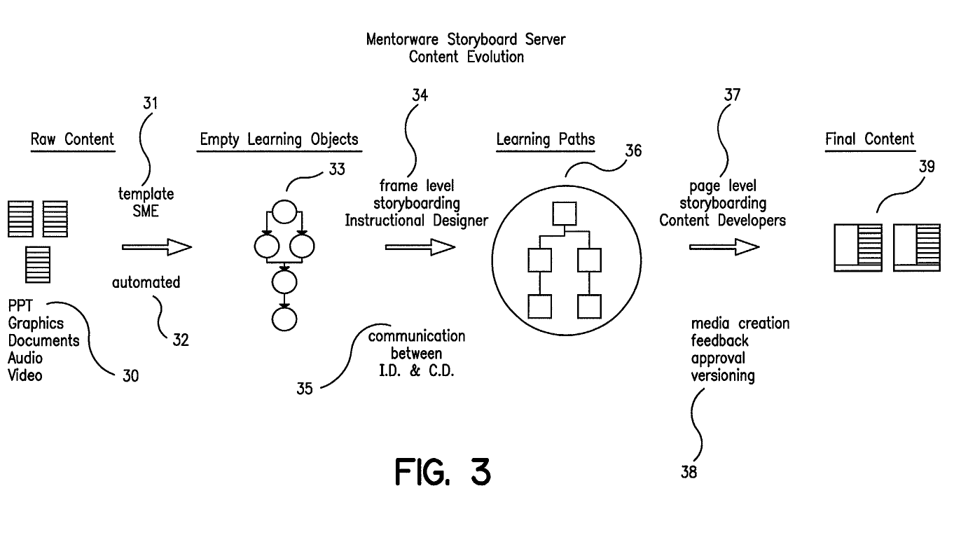

FIG. 3 depicts the method and system of the present invention. The raw content 30 or subject matter may take the form of any media or knowledge, including PPT, graphics, documents, text, audio, video, animation, or other. The raw content 30 is uploaded to the storyboard server either manually by the instructional designer or automatically 32 based upon the material submitted by the subject matter experts using the storyboard server templating engine or tool 31.

Learning objects 33 are created by the instructional designer based upon the uploaded subject matter and the frame level storyboarding 34 proceeds by the instructional designer in conjunction with others 35, including content developers. Learning paths 36 are developed by the instructional designer based upon the learning objects and the instructional designer's expertise. The framed storyboard is transferred to the content developers for page level development 37. The content developers create the relevant media for the storyboard pages, incorporate it into the network or webpages of the storyboard and receive feedback from other users and developers, such as the instructional designer and subject matter experts 38, and collaborate further with the users and developers until the final content 39 is achieved.

### EXAMPLE

The method and system of the present invention is contemplated for use by both individual network users (“B2C” offerings) and businesses (“B2B” offerings). For example:

Millions of runners across the world are able to take the client's Web-based classes on perfecting running techniques, building training schedules, and staying injury free. The classes also market the client's running accessories.

In this instance, the process of creating and developing the content begins with a client's Web-based training needs. The client needs a robust, enterprise delivery infrastructure, as well as talented HTML, graphics, and instructional designers. The Storyboard Server is a great way for the client to develop this Web-based training project.

The client contacts two dozen or so subject matter experts (SMEs), here, including a U.S. Olympic marathon coach and author of several running publications, who serves as the chief SME architect of the program. This SME, in Sydney, Australia, provides much of the domain expertise for the course material. She begins working with an instructional designer (ID). Once the ID understands how the client wants to structure their training and what audience they are targeting, she creates a template in the Storyboard Server. This template allows the SME to enter all the necessary information into the Storyboard Server. Learning Objects are then automatically created by the system using the template.

The project manager (PM), then begins looking at all the learning objects and starts identifying team members to work on the project. The ID also looks at each learning object and designs the flow of all necessary screens. The PM also identifies an HTML designer and a graphics designer. The PM appoints a technical writer from the client that works closely with the team to produce the content.

The PM takes all the screens within the learning objects and assigns them to the designers. Working remotely, the designers log into the Storyboard Server, get detailed information on the screens they are to produce, and upload the finished product. The SME also logs in and reviews the screens as they are being finished. The screens look great, but there are a few things the SME wants changed. She adds comments for the screens and the designers make the changes. At one point, the SME wants to go back to an earlier version of a screen where the new changes didn't quite work right. The Storyboard Server's version control makes this possible.

The PM logs into the server as well and makes sure the project is meeting the schedule and determines if the client is satisfied based on the SME's comments. A few issues come up during the project and the PM schedules an online conference chat through the Storyboard Server. The client, SME, PM, ID and the designers chat and make quick whiteboard drawings using Storyboard Server's live collaborative component. The SME is relieved she doesn't have to fly out to the developer's headquarters in California and the PM is relieved he didn't need to fly the designers in from India for an in-house meeting.

Because of the workflow and collaboration features of the Storyboard Server, the project is finished on time without any major problems. The client is excited to see the classes out on the Internet so fast. He was already thinking of premium training materials the client could provide for a student fee. Things could not have run more smoothly.

What is claimed is:

1. A method for developing content comprising the steps of:
incorporating subject matter on to a network-based server, including a storage medium and enabling software;
receiving input from a first actor to establish a learning path comprising one or more network-based pages comprising media;
receiving input from a second actor to establish a learning path comprising one or more network-based pages comprising media;
creating one or more learning paths based upon said subject matter; and
establishing within the server network-based pages comprising media, said pages accessible to network users collaboratively.

2. A method as in claim 1, wherein said enabling software includes a templating tool.

3. A method as in claim 2, further comprising the step of creating templates for collecting and incorporating said subject matter into said network-based server.

4. A method as in claim 3, wherein said templates are stored within and accessible from said server.

5. A method as in claim 4, wherein said templates are received electronically by users for uploading subject matter to said server.

6. A method as in claim 1, wherein said enabling software includes an authoring tool.

7. A method as in claim 1, further comprising the step of creating learning objects based upon said subject matter.

8. A method as in claim 6, wherein learning objects are automatically created by said enabling software based upon said subject matter.

9. A method as in claim 4, wherein learning objects are automatically created by said enabling software based upon subject matter incorporated in said templates.

10. A method as in claim 1, wherein said enabling software includes a storyboarding tool.

11. A method as in claim 10, further comprising the step of designing storyboards based upon said subject matter.

12. A method as in claim 9, wherein storyboarding tasks are automatically assigned by said enabling software.

13. A method as in claim 1, wherein said enabling software includes a messaging tool.

14. A method as in claim 1, wherein said enabling software includes a version control tool.

15. A method as in claim 1, wherein said enabling software includes a synchronous communication tool.

16. A system for developing content comprising:
a server, including a storage medium and enabling software, for storing subject matter, receiving input from one or more actors to establish learning paths comprising network-based pages comprising media, and enabling the establishment of network-based pages comprising media, said pages accessible to a plurality of network users collaboratively;
a network over which an opportunity to access said server is provided to a plurality of network users;
a connection between the server and the network which permits a plurality of network users to access said server.

17. A method for integrating knowledge management and content development comprising the steps of:
incorporating subject matter on to a network-based server, including a storage medium and enabling software;
receiving input from a first actor to establish a learning path comprising one or more network-based pages comprising media;
receiving input from a second actor to establish a learning path comprising one or more network-based pages comprising media;
creating one or more learning paths based upon said subject matter; and
establishing within the server network-based pages comprising media, said pages accessible to network users collaboratively.

18. A method as in claim 17, wherein said enabling software includes a templating tool.

19. A method as in claim 18, further comprising the step of creating templates for collecting and incorporating said subject matter into said network-based server.

20. A method as in claim 19, wherein said templates are stored within and accessible from said server.

21. A method as in claim 20, wherein said templates are received electronically by users for uploading subject matter to said server.

22. A method as in claim 17, wherein said enabling software includes an authoring tool.

23. A method as in claim 17, further comprising the step of creating learning objects based upon said subject matter.

24. A method as in claim 22, wherein learning objects are automatically created by said enabling software based upon said subject matter.

25. A method as in claim 20, wherein learning objects are automatically created by said enabling software based upon subject matter incorporated in said templates.

26. A method as in claim 17, wherein said enabling software includes a storyboarding tool.

27. A method as in claim 26, further comprising the step of designing storyboards based upon said subject matter.

28. A method as in claim 25, wherein storyboarding tasks are automatically assigned by said enabling software.

29. A method as in claim 17, wherein said enabling software includes a messaging tool.

30. A method as in claim 17, wherein said enabling software includes a version control tool.

31. A method as in claim 17, wherein said enabling software includes a synchronous communication tool.

32. A system for integrating knowledge management and content development comprising:
a server, including a storage medium and enabling software, for storing subject matter, receiving input from one or more actors to establish learning paths comprising network-based pages comprising media, and enabling the establishment of network-based pages comprising media, said pages accessible to a plurality of network users collaboratively;
a network over which an opportunity to access said server is provided to a plurality of network users;
a connection between the server and the network which permits a plurality of network users to access said server.
